(19) United States
(12) Patent Application Publication
(10) Pub. No.: US 2014/0327601 A1
(43) Pub. Date: Nov. 6, 2014

(54) SYSTEM AND METHOD FOR STREAMING MULTIPLE IMAGES FROM A SINGLE PROJECTOR

(71) Applicant: ELBIT SYSTEMS OF AMERICA, LLC, Fort Worth, TX (US)

(72) Inventors: Michael M. Tilleman, Brookline, MA (US); Jon R. Lyford, Londonderry, NH (US)

(73) Assignee: ELBIT SYSTEMS OF AMERICA, LLC, Fort Worth, TX (US)

(21) Appl. No.: 14/358,634

(22) PCT Filed: Nov. 14, 2012
(86) PCT No.: PCT/US12/65094

§ 371 Date: May 15, 2014

Related U.S. Application Data
(60) Provisional application No. 61/559,950, filed on Nov. 15, 2011.

(51) Int. Cl. G02B 27/01; H04N 5/74; G02B 26/08

(52) U.S. Cl. CPC G02B 27/0101; G02B 27/0172; G02B 26/0833; H04N 5/7458; G02B 2027/013
USPC 345/7

(57) ABSTRACT

A display system includes a projector system to create a plurality of image streams and a plurality of combiners, each corresponding to one of the directions of the image streams and to reflect at least a portion of the image stream received at that combiner. The projector system includes an illumination source that emits electromagnetic radiation within a predetermined spectral band, an image generator that ascribes image characteristics to the radiation to create a plurality of image streams, and an image separation module to direct the image streams in a plurality of directions.

### CROSS-REFERENCE TO RELATED APPLICATIONS

This application is a 35 U.S.C. §371 national stage application of International Application No. PCT/US2012/065094 filed Nov. 14, 2012, which claims priority to U.S. Provisional Patent Application No. 61/559,950 filed on Nov. 15, 2011, both of which are hereby incorporated herein by reference.

### BACKGROUND

State of the art Head Up Display (HUD) and Head Mounted Display (HMD) systems may use combiners disposed in the optical path between a user and a windshield, such as on a vehicle or airplane, to overlay synthetic imagery on an image of the outside scenery. These HUD and HMD systems, however, typically stream a single image from a single projector.

### BRIEF DESCRIPTION OF THE DRAWINGS

For a detailed description of exemplary embodiments, reference will now be made, by way of example only, to the accompanying drawings in which:

FIG. 1 illustrates an exemplary display system in accordance with various embodiments;

FIG. 2 illustrates another exemplary display system in accordance with various embodiments;

FIG. 3 illustrates an exemplary selecting mirror in accordance with various embodiments;

FIG. 4 illustrates another exemplary selecting mirror in accordance with various embodiments; and

FIG. 5 illustrates a flow chart of a method in accordance with various embodiments.

### NOTATION AND NOMENCLATURE

Certain terms are used throughout the following description and claims to refer to particular system components. As one skilled in the art will appreciate, certain components described herein may be referred to in the industry by multiple names. This document does not intend to distinguish between components that differ in name but not function.

In the following discussion and in the claims, the terms “including” and comprising” are used in an inclusive fashion, and thus should be interpreted to mean “including, but not limited to . . . ”, Also, the term “couple” or “couples” is intended to mean either an indirect or direct connection. Thus, if a first device couples to a second device, that connection may be through a direct connection or through an indirect connection via other devices and connections.

As used herein, the term “about” shall mean values within plus or minus five percent (+/−5%) of the recited value.

As used herein, the term “image stream” refers to a sequence of one or more images that are generated for sequential viewing by a user. The image stream comprises optical rays connecting an original figure or array of points from one to another position after a transformation.

For example, in a two-user system, a first image stream is a first video that is displayed to the first user and a second image stream is a second, different video that is displayed to the second user. As another example, in a two-user system where the users are aircraft operators, a first image stream may be augmented reality information displayed on a first combiner for the first user and a second image stream may be navigation information displayed on a second combiner for the second user.

### DETAILED DESCRIPTION

The following discussion is directed to various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

The present disclosure relates generally to imaging systems, and more particularly to a system and method for streaming multiple images from a single projector using a switching system and a plurality of combiners.

State of the art Head Up Display (HUD) and Head Mounted Display (HMD) systems may use combiners disposed in the optical path between a user and a windshield, such as on a vehicle or airplane, to overlay synthetic imagery on an image of the outside scenery. These HUD and HMD systems, however, typically stream a single image from a single projector.

Accordingly, at least one embodiment of the present disclosure includes a system that may simultaneously project and display multiple images from a single projector by de-multiplexing or de-interleaving the images. The projection and imaging system is deployable in various settings, some of which may be space constrained. In certain embodiments, de-multiplexing is achieved using at least one of the following principles: 1) time scheduling and streaming of redundant images to multiple targets, 2) modulating ray paths by polarization modulation of a polarized image, and/or 3) color separation of an image having broad spectral contents. A user may control the number of parallel images formed. For example, in some embodiments, the number of parallel images may be between one and four. In some embodiments, the projector operates in combination with a plurality of optically powered, partially reflective mirrors, known in the art as “combiners,” through which multiple users observe synthetic images. The synthetic images may overlay transmitted scenery or scenic images, resulting in a catadioptric unit. Such embodiments may be employed as HUD and/or HMD systems.

In particular embodiments, a combiner may have a coating on its inward surface with respect to the projector with spectrally preferential reflectivity to predominantly reflect a desired portion of the projected illumination and predominantly transmit light from the surroundings. In some embodiments, a combiner may also have a coating on its outward surface with respect to the projector with minimum reflectivity known in the art as anti-reflective coating so as to predominantly transmit light from the surroundings. In some embodiments, the inward surface of a combiner may be operable to reflect a finite spectral band of the electromagnetic radiation in a particular direction (e.g., toward an eye-motion box where a user observes the combiner). In certain embodiments, the inward surface of a combiner may be concave acting as reflective eyepieces and the combiner outward surfaces are convex. In such embodiments, the outward surface and inward surface of the combiner may constitute an optical element with substantially no optical-power for transmission.

The combiner may be an optical element combining the characteristics of partial reflection off the first surface and partial transmission through the entire element, where the partially reflective surface acts as an eyepiece including a reflecting surface to reflect an image to an eye-motion box, a transmissive surface an image can be seen through (i.e., a transmitted image), or both. Thus, the combiner comprises a material substantially transmissive to electromagnetic radiation within a prescribed wavelength range formed to transmit at least a substantial fraction of the ambient electromagnetic radiation within the prescribed wavelength. The electromagnetic radiation is transmitted without contribution of substantial dioptric (i.e., optical) power. The combiner further reflects at least a portion of the projected electromagnetic radiation within a prescribed wavelength so as to act as an eyepiece for the projected radiation. For example, in some embodiments, the combiner is made of a transmissive substrate, such as crown glass, fused silica, or one or more polymers, and may have any morphology (i.e., the combiner is not required to have a concave inward surface and convex outer surface).

In certain embodiments, image generation may be accomplished using spatial modulation of incident illumination in a manner in which an object is formed having a matrix representation of areas in a range between mostly bright and mostly obscure elements. As a result, a mosaic is formed constituting the object. In one embodiment, the image generator comprises a transmissive component, such as a liquid crystal panel. In another embodiment, the image generator comprises a reflective device, such as a digital micromirror device (DMD). The object thus represented may generate a synthetic image. In some embodiments, such an object may be imaged onto a diffuser, a screen, or a plane. For example, in certain embodiments including catadioptric systems, such as HUD or HMD systems, the image may be rendered in an observer's retina, with the observer viewing the virtual image overlaying real imagery from the natural field-of-view.

In particular embodiments, the projector system that creates a plurality of image streams may include an image separation module to split the image streams into a plurality of parallel channels projecting each image stream to one of a plurality of eye-motion boxes forming simultaneous images in the above mentioned manner. This allows plural viewers to view different image streams from a single projector. In some embodiments, the plural viewers view plural image streams overlaying real scenic imagery at slightly different aspects. Thus, to match the real scenic imagery, the virtual image must be accordingly modified for each viewer. Thus, in particular embodiments, disparate data sets or “image streams” may be streamed to disparate eye-motion boxes to accommodate plural viewers, despite the fact that the plural viewers may both perceive the same information.

In certain embodiments, an illumination source emits electromagnetic radiation within a predetermined spectral band. An image generator ascribes image characteristics to the radiation, which may be reflected from combiners, and may propagate toward the eye-motion boxes. One underlying principle of the present disclosure is that the reflected image streams (i.e., those reflected by the combiners) must overlap the transmitted image streams (i.e., those coming from an image generator). Accordingly, in some embodiments, first transmitted image streams propagating to a first eye-motion box may be different from second transmitted image streams propagating to a second eye-motion box. This differentiation may be accomplished in certain embodiments by interleaving or multiplexing the first and second image streams synchronously with the modulation of a switch whose function is to direct the first and second image streams to the first and second eye-motion boxes, respectively.

In some embodiments, the combiners may reflect electromagnetic radiation in the spectral band of about 510-550 nanometers. The combiners may also have inner surfaces that reflect at least 70% of the illumination in spectral bands centered around about 450-480 nanometers, 510-550 nanometers, and 610-650 nanometers. Further, the combiners may transmit at least 80% of illumination in the spectral band of about 380-710 nanometers.

For example, in particular embodiments, the image generator may be a Texas Instruments (TI) Digital Micromirror Device (DMD) having an XGA configuration (i.e. 1024×768 pixels), operating at a bandwidth of 200 MHz per pixel. Such embodiments will therefore have a frame rate of 240 Hz. Because the bandwidth of eye perception is approximately 25 Hz, an image may be interleaved or multiplexed several times over, allowing for particular embodiments of the present disclosure to direct the several interleaved image streams to multiple respective viewers.

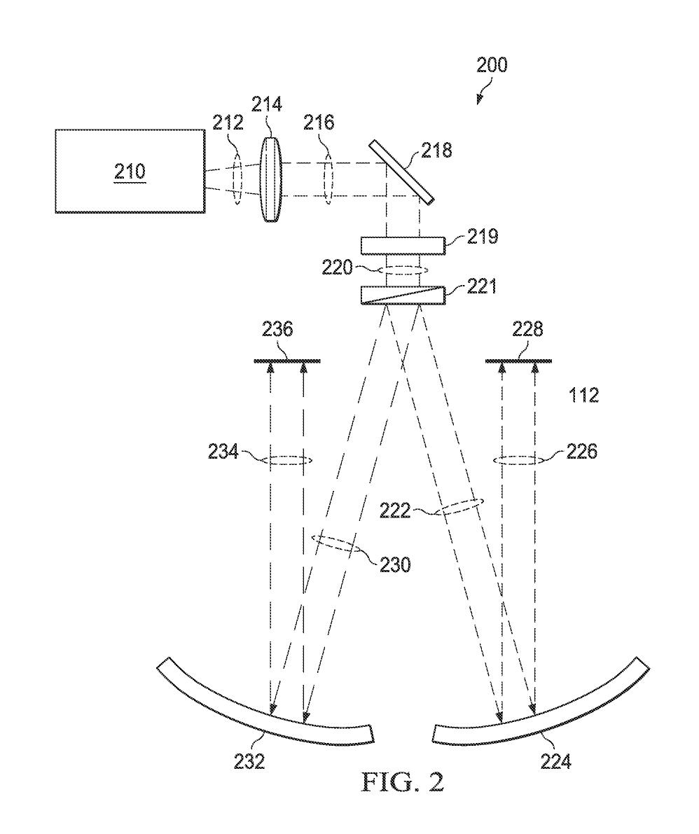

Several mechanisms may be used to switch the image streams between the combiners. For example, in some embodiments, the electromagnetic radiation containing the image streams may be linearly polarized, passing through a variable phase retarder and a polarizing beamsplitter, as shown in FIG. 2. Depending on the state of polarization of the radiation coming out of the variable phase retarder, the image stream may be switched between propagating on the path to a particular eye-motion box. For example, radiation coming out of the phase retarder may comprise rays with two different polarizations. In this example, the beamsplitter directs the rays with first polarization to a first eye-motion box, while simultaneously directing the rays with second polarization to a second eye-motion box. In some cases, the rays with the first polarization correspond to a first image stream while the rays with the second polarization correspond to a second image stream. The image streams may differ by perspective based on the position of the eye-motion boxes (i.e., the multiple users view approximately the same information, corrected for the perspective of the user relative to, for example, scenic imagery) or may differ by content (i.e., the multiple users view different information).

In some embodiments, the variable phase retarder may be realized by a liquid crystal (LC) modulator that modulates or alters the polarization state of the beam. For example, the LC modulator may have a bandwidth of 2 kHz, making it compatible with the required switching rate. In some embodiments, the LC modulator may be utilized to modulate the optical beam into a circular polarization having a right or left hand sense. In such embodiments, two additional LC modulators may be deployed past the two optical paths following a first polarization beamsplitter to further switch between two linear polarizations that are selectable by two additional polarization beamsplitters, thus providing a four way switching capability.

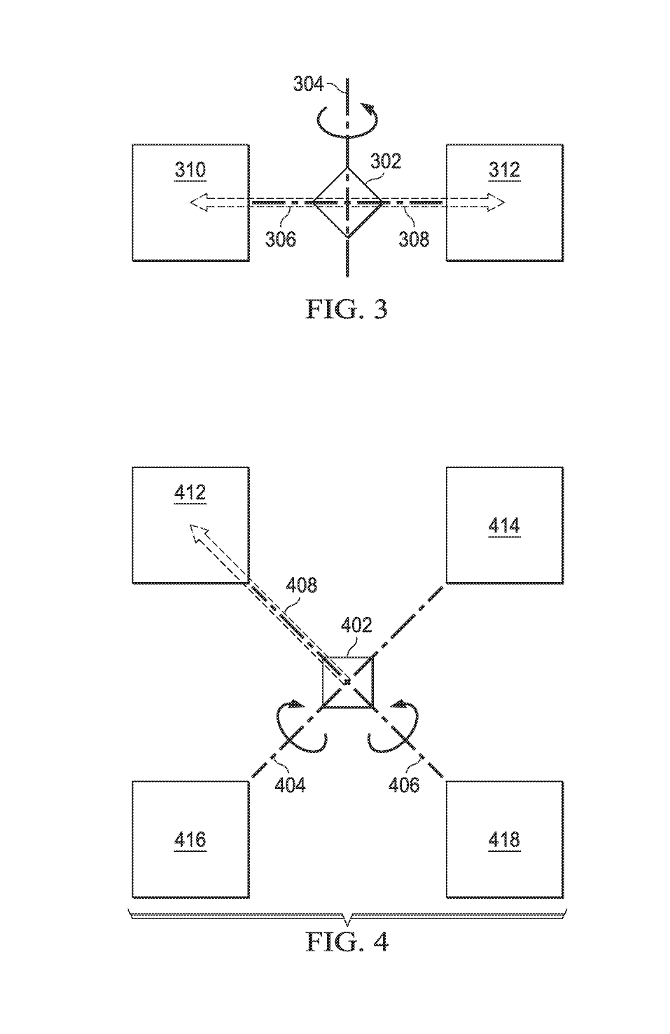

In some embodiments, the switch is realized by a mirror having at least two stable angular positions, where the image streams are incident on the mirror. The image streams may be modulated between the two angular positions, thus steering each image stream towards one of a plurality of eye-motion boxes, as shown in FIG. 3. In particular embodiments, the switching mirror may be realized by a Micro Electro-Mechanical System (MEMS) type mirror, which may have two degrees of angular freedom and four stable angular positions, thus steering the image streams towards four different viewers, as shown in FIG. 4. The MEMS may have a switching bandwidth of 120 Hz, thus making it compatible with the required switching rate.

One of ordinary skill in the art will appreciate that some or all of the above switching mechanisms may be combined in a cascaded fashion to provide a larger amount of switching positions. Such embodiments may thus allow for switching between a plurality of simultaneous, however different, virtual images. For example, and not by way of limitation, some embodiments may allow for switching between eight simultaneous, but different virtual images.

Although example implementations of embodiments of the present disclosure are illustrated below, the teachings of the present disclosure should in no way be limited to the example implementations, drawings, and techniques illustrated below. Additionally, the drawings are not necessarily drawn to scale. Although particular embodiments are explained herein with reference to HUD and/or HMD systems using a flat combiner, particular systems and methods disclosed herein may be used to project synthetic imagery along with scenic imagery using a flat combiner in any suitable application.

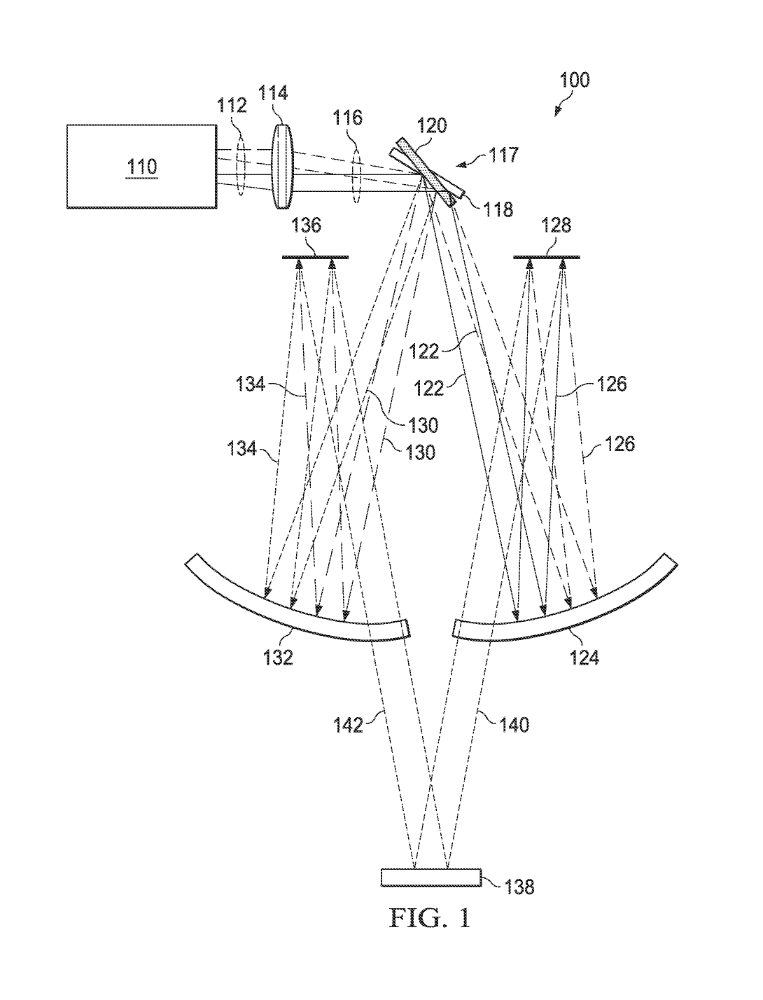

FIG. 1 illustrates a display system 100 comprising a projector 110, a selecting mirror 120, and two combiners 124, 132. Projector 110 includes an illumination source (not shown) and image generator (not shown). The illumination source emits electromagnetic radiation within a predetermined spectral band, such as the visible frequency band, and the image generator 111 ascribes image characteristics to the radiation. For example, synthetic imagery and/or symbology may be ascribed to the radiation such that, when reflected off of the combiners 124, 132 toward eye-motion boxes 128, 136, users at the eye-motion boxes 128, 136 view the synthetic imagery and/or symbology as an overlay of scenic imagery (e.g., an object 138) transmitted by the combiners 124, 132.

Rays 112 may originate at the center and periphery of the image generator and may propagate to an imaging lens 114. In some embodiments, the imaging lens 114 may be a lens group comprising a plurality of lenses. All light rays within the numerical aperture (NA) of imaging lens 114 may emerge as rays 116 that are then reflected by a switching mirror 117 resting at a stable position 118. Rays 116 are reflected off of the mirror 117 becoming 122, then impinging on combiner 124 and being partially reflected, becoming rays 126. Finally the rays form an image on eye-motion box 128. Alternatively, the switching mirror 117 may have a second stable position 120 depicted by the grey mirror representation. If the selecting mirror 117 rests in position 120, rays 116 are reflected off of the selecting mirror 120 becoming rays 130, then impinging on combiner 132 and being partially reflected, becoming rays 134. Finally, rays 134 may form an image on eye-motion box 136.

In particular embodiments, the switching mirror 117 may be operable to switch between two or more stable positions (such as positions 118 and 120 in FIG. 1) such that two or more image streams being multiplexed with respect to time may be directed to two or more combiners. For example, the projector image generator 111 may emit first rays forming a first image at t=1, and second rays forming a second image at t=2. The first rays correspond to a first image stream and the second rays correspond to a second image stream. The selecting mirror 117 may be at stable position 118 at t=1 in order to reflect the first rays toward combiner 124, and may be at stable position 120 at t=2 in order to reflect the second rays toward combiner 132. Accordingly, the first image stream is displayed at eye-motion box 128 and the second image stream is displayed at eye-motion box 136.

Furthermore, object 138 may scatter off rays 140 and 142. In some embodiments, combiners 124 and 132 are transparent for certain wavelengths of light (e.g., the visible spectrum). In further embodiments, combiners may be operable to transmit rays 140 and 142. In such embodiments, rays 140 and 142 may be incident on eye-motion boxes 128 and 136, respectively. In particular embodiments, combiners 124 and 132 may form reflective eyepieces that collimate the rays 126 and 134.

FIG. 2 illustrates another display system 200 comprising a projector 210, a reflecting mirror 210, a variable phase retarder 218, a polarizing beam splitter 221, and two combiners 224, 232. The projector 210 includes an illumination source (not shown) and an image generator (not shown). Similar to above, the illumination source emits electromagnetic radiation within a predetermined spectral band, such as the visible frequency band, and the image generator ascribes image characteristics to the radiation. For example, synthetic imagery and/or symbology may be ascribed to the radiation such that, when reflected off of the combiners 224, 232 toward eye-motion boxes 228, 236, users at the eye-motion boxes 228, 236 view the synthetic imagery and/or symbology as an overlay of scenic imagery transmitted by the combiners 224, 232.

Rays 212 may originate at the image generator center and periphery. All light rays within the NA of imaging lens 214 may emerge as rays 216 that are then directed to mirror 218. In some embodiments, the imaging lens 218 may be a lens group comprising a plurality of lenses. The mirror 218 may reflect to a variable phase retarder 219. The variable phase retarder 219 may alter the polarization of light rays based on the polarization of the rays. In some embodiments, the variable phase retarder 219 may be tunable via an externally-applied electric current.

Rays 220 may be emitted from the variable phase retarder 219 with two or more different polarizations. Rays 220 may then propagate to a polarizing beam splitter 221. The polarizing beam splitter 221 may direct the rays with two or more different polarizations in two or more respective directions. For example, rays 220 may comprise rays with a first polarization and rays with a second polarization. The rays 220 with a first polarization correspond to a first image stream and the rays 220 with a second polarization correspond to a second image stream. When entering the polarizing beam splitter 221, rays 220 with first polarization become rays 222, while rays 220 with second polarization become rays 230. Rays 222 and 230 then impinge upon combiners 224 and 232, respectively. The combiners 224 and 232 then at least partially reflect rays 222 and 230 as rays 226 and 234, respectively. Finally, rays 226 and 234 are incident on eye-motion boxes 228 and 236, respectively. In particular embodiments, combiners 224 and 232 may form reflective eyepieces that collimate the rays 226 and 234.

FIG. 3 illustrates an example switching mirror 302 rotating around an axis 304 with two stable rest positions and two combiners 310, 312. The switching mirror 302 rotates about axis 304, and may have two stable rest positions. When the switching mirror 302 rests at one of the two stable positions, it casts rays 306 to a corresponding combiner 310. Likewise, when the switching mirror 302 rests at the second of the two stable positions, it casts rays 308 to a corresponding combiner 312. Accordingly, the switching mirror 302 reflects two separate images being projected sequentially.

FIG. 4 illustrates an example switching mirror 402 swiveling around two axes 404, 406 with four stable rest positions and four combiners 412, 414, 416, 418. The switching mirror 402 swivels around two orthogonal axes 404 and 406, and may have four stable rest positions. When the switching mirror 402 rests at one of the four stable positions, it may cast rays 408 to a corresponding combiner 412. Likewise, when switching mirror 402 rests at one of the three other stable positions, it may cast rays respectively to combiners 414, 416 and 418. Accordingly, the switching mirror 402 may be operable to reflect four separate images being projected sequentially.

The switching mirrors of FIGS. 3 and 4 are exemplary. However, the present disclosure is intended to encompass other such synchronized optical switching elements that are known in the art.

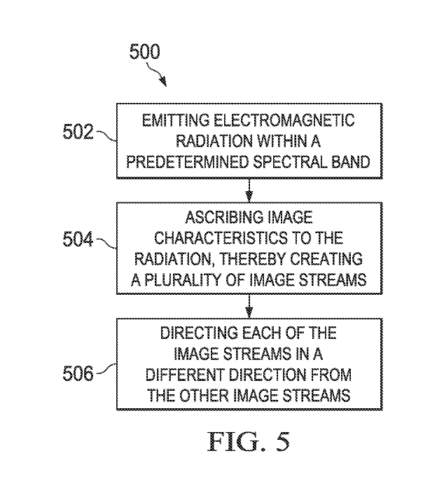

FIG. 5 shows a method 500 in accordance with various embodiments. The method 500 begins in block 502 with emitting electromagnetic radiation within a predetermined spectral band. In some embodiments, the electromagnetic radiation is in the visible spectrum. The method 500 then continues in block 504 with ascribing image characteristics to the radiation. For example, the image characteristics may comprise synthetic imagery to be overlaid on actual scenic imagery (i.e., that is transmitted through a combiner) and/or symbology that represents various information that may be useful to a user. In accordance with various embodiments, information from the image characteristics are ascribed to the radiation such that a plurality of image streams are created, with each image stream representing information desired to be viewed by different users. As explained above, the image streams may differ by perspective based on the position of the user (i.e., the multiple users view approximately the same information, corrected for the perspective of the user relative to, for example, scenic imagery) or may differ by content (i.e., the multiple users view different information). The method further continues in block 506 with directing each of the image streams in a different direction from the other image streams. This can be done using a synchronized optical switching element, a combination of a variable phase retarder and a polarizing beam splitter, or other such optical elements.

Particular embodiments of the present disclosure may provide one or more technical advantages. For example, certain embodiments may allow for several image streams intended for several targets to be interleaved or multiplexed into a single beam and transmitted simultaneously. As another example, certain embodiments may direct several interleaved image streams to multiple respective viewers by de-multiplexing the several image streams with a switching system.

Certain embodiments may provide all, some, or none of these advantages. Certain embodiments may provide one or more other advantages, one or more of which may be apparent to those skilled in the art from the figures, descriptions, and claims included herein.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

What is claimed is:

1. A display system comprising:
a projector system to create a plurality of image streams, comprising:
an illumination source that emits electromagnetic radiation within a predetermined spectral band;
an image generator that ascribes image characteristics to the radiation to create a plurality of image streams; and
an image separation module to direct the image streams in a plurality of directions; and
a plurality of combiners, each corresponding to one of the directions of the image streams and to reflect at least a portion of the image stream received at that combiner.

2. The display system of claim 1 wherein the image separation module comprises a switching mirror to move between a plurality of rest positions and to direct the image streams in a respective particular direction based on the rest position.

3. The display system of claim 2 wherein the switching mirror comprises a micro electrical-mechanical system (MEMS) mirror.

4. The display system of claim 1 wherein the image separation module comprises:
a variable phase retarder to alter the polarization of each of the image streams based on the polarization of the image stream; and
a polarizing beam splitter to direct each image stream in a particular direction based on the polarization of the image stream.

5. The display system of claim 4 wherein the variable phase retarder is a liquid crystal modulator.

6. The display system of claim 1 wherein the image generator interleaves image streams intended for multiple targets into a single beam and transmits the interleaved image streams simultaneously.

7. The display system of claim 6 wherein the image separation module deinterleaves the image streams such that the image stream intended for a target corresponding to a first combiner is directed to the first combiner and the image stream intended for a target corresponding to a second combiner is directed to the second combiner.

8. The display system of claim 1 wherein the image generator multiplexes image streams intended for multiple targets into a single beam and transmits the multiplexed image streams simultaneously.

9. The display system of claim 8 wherein the image separation module demultiplexes the image streams such that the image stream intended for a target corresponding to a first combiner is directed to the first combiner and the image stream intended for a target corresponding to a second combiner is directed to the second combiner.

10. The display system of claim 1 wherein the combiners comprise an inner surface to reflect a finite spectral band of the image stream and an outer surface to transmit visible light with substantially no deviation from an incident angle of the visible light on the outer surface.

11. The display system of claim 1 wherein each combiner directs collimated rays to an associated eye-motion box.

12. The display system of claim 1 wherein at least one combiner comprises a first concave surface and a second convex surface, wherein the first surface reflects and collimates at least a portion of the image stream and the combiner transmits visible light with substantially no deviation from an incident angle of the visible light on the outer surface.

13. A method, comprising:
emitting electromagnetic radiation within a predetermined spectral band;
ascribing image characteristics to the radiation, thereby creating a plurality of image streams;
directing each of the image streams in a different direction from the other image streams.

14. The method of claim 13 wherein image characteristics from a first and second image stream are ascribed to the radiation in a time multiplexed manner and the method further comprises directing the first image stream in a first direction and directing the second image stream in a second direction with a synchronized optical switching element.

15. The method of claim 13 wherein the electromagnetic radiation comprises beams having a first and second polarization and image characteristics from a first image stream are ascribed to the beams having the first polarization and image characteristics from a second image stream are ascribed to the beams having the second polarization and the method further comprises directing each image stream in a particular direction based on the polarization of the image stream.

16. The method of claim 13 further comprising:
interleaving image streams intended for multiple targets into a single beam; and
transmitting the interleaved image streams simultaneously.

17. The method of claim 16 further comprising deinterleaving the image streams such that the image stream intended for a target corresponding to a first combiner is directed to the first combiner and the image stream intended for a target corresponding to a second combiner is directed to the second combiner.

18. The method of claim 13 further comprising:
multiplexing image streams intended for multiple targets into a single beam; and
transmitting the multiplexed image streams simultaneously.

19. The method of claim 18 further comprising demultiplexing the image streams such that the image stream intended for a target corresponding to a first combiner is directed to the first combiner and the image stream intended for a target corresponding to a second combiner is directed to the second combiner.
